(19) United States
(12) Patent Application Publication
(10) Pub. No.: US 2023/0137024 A1
(43) Pub. Date: May 4, 2023

(54) APPARATUS FOR MANUFACTURING PLASTIC OPTICAL FIBER AND METHOD FOR MANUFACTURING PLASTIC OPTICAL FIBER

(71) Applicant: NITTO DENKO CORPORATION, Ibaraki-shi, Osaka (JP)

(72) Inventors: Hajime Michihira, Osaka (JP); Akifumi Kido, Osaka (JP); Takashi Kumano, Osaka (JP); Yuto Nagaya, Osaka (JP)

(73) Assignee: NITTO DENKO CORPORATION, Ibaraki-shi, Osaka (JP)

(21) Appl. No.: 17/915,680

(22) PCT Filed: Nov. 6, 2020
(86) PCT No.: PCT/JP2020/041617

§ 371 Date: Sep. 29, 2022

(30) Foreign Application Priority Data
Mar. 31, 2020 (JP) 2020-065245

(51) Int. Cl. B29C 48/37; C08G 64/02; B29C 48/05

(52) U.S. Cl. CPC B29C 48/37; C08G 64/0233; B29C 48/05; G02B 1/045

(57) ABSTRACT

The present invention provides an apparatus for manufacturing a plastic optical fiber suitable for adjusting a plastic optical fiber to be uniform in size while inhibiting the entry of a metal that causes an increase in transmission loss of the plastic optical fiber. The apparatus for manufacturing a plastic optical fiber of the present invention is provided with an extruding device and a gear pump. The extruding device has a containing portion that contains a resin composition, and introduces a gas into the containing portion to extrude the resin composition from the containing portion by means of the gas. The gear pump adjusts a flow rate of the resin composition extruded from the extruding device.

### TECHNICAL FIELD

The present invention relates to an apparatus for manufacturing a plastic optical fiber and a method for manufacturing a plastic optical fiber.

### BACKGROUND ART

Plastic optical fibers are excellent in terms of low manufacturing cost, high flexibility, and high processability compared to quartz glass optical fibers. Plastic optical fibers are chiefly used as transmission media for short-distance (100 m or less, for example) use.

A plastic optical fiber is commonly provided with a core located in a central portion and configured to transmit light and a clad coating an outer circumference of the core, as a glass optical fiber does. The core of a plastic optical fiber is formed of a resin having a high refractive index, while the clad thereof is formed of a resin having a refractive index lower than that of the resin of the core.

A plastic optical fiber can be manufactured by melt spinning. for example. In the melt spinning, a resin composition is extruded from an extruding device to shape the resin composition into a fibrous shape. For example, Patent Literature 1 discloses extruding, by using an extruding device provided with a screw, a resin composition from the extruding device. Patent Literature 2 discloses introducing a gas into an extruding device and pressing a resin composition by means of the gas to extrude the resin composition from the extruding device.

### CITATION LIST

### Patent Literature

Patent Literature 1: JP 2000-356716 A

Patent Literature 2: U.S. Pat. No. 6,527,986

### SUMMARY OF INVENTION

### Technical Problem

In the case where an extruding device provided with a screw extrudes a resin composition, the screw rubs against a wall surface of a containing portion containing the resin composition. Thus, the screw and/or the containing portion is slightly scraped and a material, such as a metal, of them enter into the resin composition. The entry of a metal into the resin composition tends to increase transmission loss of a plastic optical fiber having a core formed of the resin composition even if the amount the metal entry is very small.

An extruding device using a gas makes it possible to inhibit a metal from entering into a resin composition. However, in the case where the resin composition is shaped into a fibrous shape using this extruding device, the obtained shaped body tends to be ununiform in size (diameter).

Therefore, the present invention is intended to provide an apparatus for manufacturing a plastic optical fiber suitable for adjusting a plastic optical fiber to be uniform in size while inhibiting the entry of a metal that causes an increase in transmission loss of the plastic optical fiber.

### Solution to Problem

Studies by the present inventors have found that in the case of an extruding device using a gas, when a resin composition is ununiform in viscosity and temperature, a flow rate of the resin composition extruded changes even if a pressure of the gas to be introduced is maintained constant. In addition, they have found that when a stagnant matter is present in a flow path, a pressure loss changes, and the flow rate changes accordingly. The present inventors have discovered that this change in flow rate is a factor that makes the fibrous shaped body ununiform in size. The present invention has been completed on the basis of this finding.

The present invention provides an apparatus for manufacturing a plastic optical fiber, including:

an extruding device that has a containing portion that contains a resin composition, and introduces a gas into the containing portion to extrude the resin composition from the containing portion by means of the gas; and

a gear pump that adjusts a flow rate of the resin composition extruded from the extruding device.

### Advantageous Effects of Invention

The present invention can provide an apparatus for manufacturing a plastic optical fiber suitable for adjusting a plastic optical fiber to be uniform in size while inhibiting the entry of a metal that causes an increase in transmission loss of the plastic optical fiber.

### BRIEF DESCRIPTION OF DRAWINGS

FIG. 1 is a diagram showing an example of an apparatus for manufacturing a plastic optical fiber.

FIG. 2 is a diagram for explaining a pair of gears that a gear pump has.

FIG. 3 is an enlarged view of area III shown in FIG. 2.

FIG. 4 is a cross-sectional view of the gear pump, showing an outer peripheral surface of the pair of gears that the gear pump has.

FIG. 5 is a diagram showing another example of the apparatus for manufacturing a plastic optical fiber.

FIG. 6 is a graph showing a relationship between maximum values τ_{TC} and τ_{SC} of respective shearing stresses in each of Measurement Examples 1 to 18.

### DESCRIPTION OF EMBODIMENTS

In another aspect, the present invention provides a method for manufacturing a plastic optical fiber by using the above-mentioned manufacturing apparatus, including

causing the resin composition extruded from the extruding device to pass through the gear pump, wherein

the gear pump has a housing with an inside through which the resin composition passes, and one or more pairs of gears that are contained in the housing and mesh with each other, and

when a maximum value of a shearing stress generated in the resin composition between a tooth portion of one of the one or more pairs of gears and the housing is denoted as τ_{TC} (kPa) and a maximum value of a shearing stress generated in the resin composition between a side of the gear and the housing is denoted as τ_{SC} (kPa), relational expression (I) below is satisfied.

τ_{TS}≤−τ_{TC}+1200 (I)

According to one embodiment of the present invention, in the above-mentioned manufacturing method, at least one selected from the group consisting of a distance between the tooth portion of the gear and the housing and a distance between the side of the gear and the housing is 5 μm or more.

According to one embodiment of the present invention, in the above-mentioned manufacturing method, the side of the gear has a diameter of 80 mm or less.

According to one embodiment of the present invention, in the above-mentioned manufacturing method, the number of rotations of the gear is 100 rpm or less.

According to one embodiment of the present invention, in the above-mentioned manufacturing method, an inner surface of the housing is composed of a material having corrosion resistance against the resin composition.

According to one embodiment of the present invention, in the above-mentioned manufacturing method, a surface of the one or more pairs of gears is composed of a material having corrosion resistance against the resin composition.

According to one embodiment of the present invention, in the above-mentioned manufacturing method. the material having corrosion resistance against the resin composition includes at least one selected from the group consisting of Hastelloy and Stellite.

In another aspect, the present invention provides a method for manufacturing a plastic optical fiber by using the above-mentioned manufacturing apparatus, including:

extruding the resin composition from the extruding device, wherein

the resin composition extruded from the extruding device has a viscosity of 1 to 7000 Pa·s.

In another aspect, the present invention provides a method for manufacturing a plastic optical fiber by using the above-mentioned manufacturing apparatus, including:

sending out the resin composition from the gear pump, wherein

the resin composition sent out from the gear pump has a flow rate of 20 L/min or less.

In another aspect, the present invention provides a method for manufacturing a plastic optical fiber by using the above-mentioned manufacturing apparatus, including:

causing the resin composition extruded from the extruding device to pass through the gear pump, wherein

an increase in a concentration of a metal in the resin composition from before to after the resin composition passes through the gear pump is 100 mass ppm or less.

In another aspect, the present invention provides a method for manufacturing a plastic optical fiber by using the above-mentioned manufacturing apparatus, including

manufacturing a plastic optical fiber by using a resin composition including a polymer having a structural unit represented by formula (1) below:

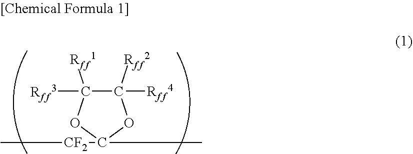

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

In another aspect, the present invention provides a method for manufacturing a plastic optical fiber by using the above-mentioned manufacturing apparatus, including:

shaping the resin composition sent out from the gear pump into a fibrous shape.

In another aspect, the present invention provides an apparatus for manufacturing a plastic optical fiber, including:

an extruding device that has a containing portion that contains a resin composition, and introduces a gas into the containing portion to extrude the resin composition from the containing portion; and

a gear pump that adjusts a flow rate of the resin composition extruded from the extruding device.

According to one embodiment of the present invention, in the above-mentioned manufacturing apparatus, the gear pump has a housing with an inside through which the resin composition passes, and one or more pairs of gears that are contained in the housing and mesh with each other, and

when a maximum value of a shearing stress generated in the resin composition between a tooth portion of one of the one or more pairs of gears and the housing is denoted as τ_{TC} (kPa) and a maximum value of a shearing stress generated in the resin composition between a side of the gear and the housing is denoted as τ_{SC} (kPa), relational expression (I) below is satisfied.

τ_{TS}≤−τ_{TC}+1200 (I)

According to one embodiment of the present invention, in the above-mentioned manufacturing apparatus, at least one selected from the group consisting of a distance between the tooth portion of the gear and the housing and a distance between the side of the gear and the housing is 5 μm or more.

According to one embodiment of the present invention, in the above-mentioned manufacturing apparatus. the side of the gear has a diameter of 80 mm or less.

According to one embodiment of the present invention, in the above-mentioned manufacturing apparatus, the number of rotations of the gear is 100 rpm or less.

According to one embodiment of the present invention, in the above-mentioned manufacturing apparatus, an inner surface of the housing is composed of a material having corrosion resistance against the resin composition.

According to one embodiment of the present invention, in the above-mentioned manufacturing apparatus, a surface of the one or more pairs of gears is composed of a material having corrosion resistance against the resin composition.

According to one embodiment of the present invention, in the above-mentioned manufacturing apparatus, the material having corrosion resistance against the resin composition includes at least one selected from the group consisting of Hastelloy and Stellite.

According to one embodiment of the present invention, in the above-mentioned manufacturing apparatus, the resin composition extruded from the extruding device has a viscosity of 1 to 7000 Pa·s.

According to one embodiment of the present invention, in the above-mentioned manufacturing apparatus, the resin composition sent out from the gear pump has a flow rate of 20 L/min or less.

According to one embodiment of the present invention, in the above-mentioned manufacturing apparatus, an increase in a concentration of a metal in the resin composition from before to after the resin composition passes through the gear pump is 100 mass ppm or less.

According to one embodiment of the present invention, in the above-mentioned manufacturing apparatus, the resin composition includes a polymer having a structural unit represented by formula (1) below:

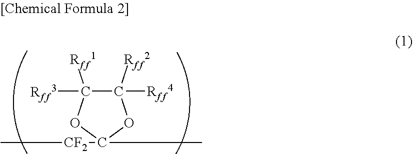

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

According to one embodiment of the present invention, the above-mentioned manufacturing apparatus shapes the resin composition sent out from the gear pump into a fibrous shape.

Hereinafter, embodiments of the present invention will be described. The following description is not intended to limit the present invention to specific embodiments.

### EMBODIMENT 1

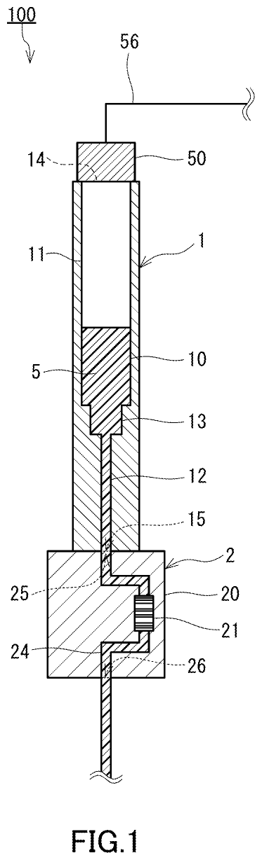

As shown in FIG. 1, an apparatus 100 for manufacturing a plastic optical fiber (POF) according to the present embodiment 1 is provided with an extruding device 1 and a gear pump 2. The extruding device 1 has a containing portion 10 that contains a resin composition 5, and can introduces a gas into the containing portion 10 to extrude the resin composition 5 from the containing portion 10. The gear pump 2 adjusts a flow rate of the resin composition 5 extruded from the extruding device 1.

The containing portion 10 of the extruding device 1 is a tubular member whose internal space communicates with the outside at a first opening portion 14 located on an upper side and a second opening portion 15 located on a lower side. The containing portion 10 has, for example, a first tubular portion 11, a second tubular portion 12, and a tubular diameter-shrinking portion 13 connecting the first tubular portion 11 and, the second tubular portion 12. The first tubular portion 11, the second tubular portion 12, and the diameter-shrinking portion 13 each have, for example, a cylindrical shape. The first tubular portion 11 has an inner diameter larger than an inner diameter of the diameter-shrinking portion 13. The diameter-shrinking portion 13 has an inner diameter larger than an inner diameter of the second tubular portion 12. The diameter-shrinking portion 13 may have the shape of a truncated cone whose diameter shrinks from the first tubular portion 11 toward the second tubular portion 12. In the containing portion 10, the first opening portion 14 is formed at an end portion of the first tubular portion 11 and the second opening portion 15 is formed at an end portion of the second tubular portion 12. The second opening portion 15 of the containing portion 10 is connected to a later-described inlet 25 of the gear pump 2.

The extruding device 1 is further provided with a lid 50. in the state in which the containing portion 10 contains the resin composition 5. the first opening portion 14 of the containing portion 10 is closed by the lid 50. A pipe 56 is connected to the lid 50. A gas can be sent to the containing portion 10 through the pipe 56. Preferably, the gas to be sent to the containing portion 10 is an inert gas such as a nitrogen gas. The pipe 56 is connected to a high-pressure gas cylinder, for example, and it is possible to adjust a gas pressure by handling a pressure-reducing valve.

The extruding device 1 may be further provided with a heater (not illustrated) that heats the resin composition 5 contained in the containing portion 10. The type, installation location, etc. of the heater are not particularly limited. In one example, the heater may be installed near the diameter-shrinking portion 13 of the containing portion 10.

The resin composition 5 (a preform) in a rod shape is inserted into the first tubular portion 11 of the containing portion 10 through the first opening portion 14, for example. The resin composition 5 in a rod shape is softened and becomes able to flow by being heated, for example. The softened resin composition 5 is extruded from the containing portion 10 using a pressure difference between the first opening portion 14 and the second opening portion 15, for example. Specifically, the gas is introduced into the containing portion 10 from the first opening portion 14 to press an upper surface of the resin composition 5, and thereby the softened resin composition 5 moves to the diameter-shrinking portion 13 and the second tubular portion 12 and is extruded from the second opening portion 15. The resin composition 5 extruded from the second opening portion 15 is sent to the gear pump 2 through the inlet 25 of the gear pump 2. FIG. 1 shows the state in which the softened resin composition 5 is being extruded from the second opening portion 15. A temperature at which the resin composition 5 is heated can be appropriately set according to a composition of the resin composition 5, and it is 100° C. to 250° C., for example. The resin composition 5 extruded from the extruding device 1 has a viscosity μ that is, for example, but not particularly limited to, 1 to 7000 Pa·s, preferably 500 to 7000 Pa·s, more preferably 5000 Pa·s or less, and still more preferably 3000 Pa·s or less.

The gear pump 2 has a housing 20 and one or more pairs of gears (a pair of gears 21, for example). FIG. 1 shows an outer peripheral surface of one of the pair of gears 21. A flow path 24 through which the resin composition 5 passes is formed inside the housing 20. The pair of gears 21 are contained in the housing 20, and specifically they are disposed in the flow path 24 inside the housing 20. In other words, a space in which the pair of gears 21 are disposed is provided inside the housing 20.

The gear pump 2 has the inlet 25 and also an outlet 26 for the resin composition 5. The inlet 25 is formed on an upper side of the housing 20, for example. The outlet 26 is formed on a lower side of the housing 20, for example. The above-mentioned flow path 24 extends from the inlet 25 up to the outlet 26 of the housing 20. The resin composition 5 extruded from the extruding device 1 is sent to the flow path 24 through the inlet 25 of the gear pump 2. The flow rate of the resin composition 5 is adjusted by the pair of gears 21, and then the resin composition 5 is sent out from the gear pump 2 through the outlet 26. In the present embodiment, the flow rate of the resin composition 5 sent out from the gear pump 2 is, for example, but not particularly limited to, 20 L/min or less, preferably 10 mL/min or less, more preferably 1.0 mL/min or less, still more preferably 0.5 mL/min or less, and particularly preferably 0.1 mL/min or less. The lower limit of the flow rate of the resin composition 5 sent out from the gear pump 2 is, for example, but not particularly limited to, 0.001 mL/min. It should be noted that it is usually difficult for an extruding device provided with a screw to adjust a flow rate of an extruded resin composition to a small value. Thus, it is difficult to adjust the flow rate of the resin composition extruded from the extruding device provided with a screw to 1.0 mL/min or less even if a gear pump is used.

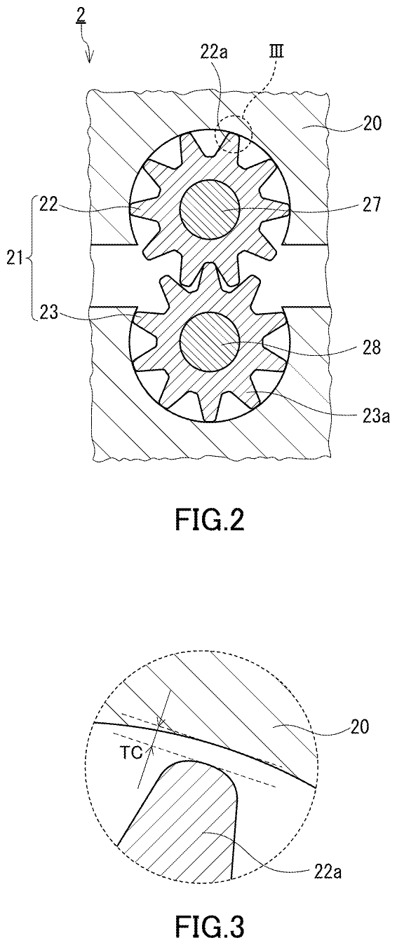

FIG. 2 shows a sectional side view of the pair of gears 21. The pair of gears 21 include, for example, a driving gear 22 and a driven gear 23, and these gears 22 and 23 mesh with each other. The gear pump 2 further has a driving shaft 27 connected to the driving gear 22, a driven shaft 28 connected to the driven gear 23, and a servomotor (not illustrated) connected to the driving shaft, 27. The servomotor is driven to transmit a power from the driving shaft 27 to the driving gear 22. This makes the driving gear 22 rotate and also the driven gear 23 rotate. The rotations of the gears 22 and 23 are controlled to adjust the flow rate of the resin composition 5. A number N of rotations of the driving gear 22 (or the driven gear 23) is, for example, but not particularly limited to, 100 rpm or less, and it is controlled preferably to 30 rpm or less, more preferably to 20 rpm or less, still more preferably to 15 rpm or less, particularly preferably to 10 rpm or less, and especially preferably to 5 rpm or less. The lower limit of the number N of rotations is, for example, but not particularly limited to, 0.1 rpm.

The driving gear 22 may have dimensions and a shape identical to or different from those of the driven gear 23. A diameter D of a side of the driving gear 22 (or the driven gear 23) is, for example, but not particularly limited to, 80 mm or less, preferably 30 mm or less, more preferably 25 mm or less, still more preferably 20 mm or less, and particularly preferably 15 mm or less. The lower limit of the diameter D is, for example, but not particularly limited to, 5 mm. The “diameter of the side of the gear” as used herein means the diameter of the smallest circle that can surround a periphery of the side of the gear.

Preferably, a tooth portion 22a (or a tooth portion 23a) included in the driving gear 22 (or the driven gear 23) is out of contact with the housing 20 when the driving gear 22 (or the driven gear 23) is rotating. FIG. 3 is an enlarged view near a tip of the tooth portion 22a of the driving gear 22. A distance (a top clearance) TC between the tooth portion 22a of the driving gear 22 (or the tooth portion 23a of the driven gear 23) and the housing 20 is, for example, but not particularly limited to, 5 μm or more, preferably 10 μm or more, more preferably 30 μm or more, still more preferably 50 μm or more, particularly preferably 80 μm or more, and especially preferably 100 μm or more. In the present description, the top clearance TC may be a designed value of the distance between the tooth portion of the gear and the housing, or may be a minimum value of that distance. There is a tendency that as the top clearance TC increases, a shearing stress generated in the resin composition 5 between the tooth portion 22a (or the tooth portion 23a) and the housing 20 can be more reduced. The reduction in the shearing stress generated in the resin composition 5 makes it possible to inhibit the tooth portion 22a (or the tooth portion 23a) and the housing 20 from being scraped when the driving gear 22 (or the driven gear 23) is rotating. In other words, as the top clearance TC increases, materials of the gear 22, the gear 23 and the housing 20 can be more inhibited from entering into the resin composition 5. In view of maintaining sufficiently the efficiency of the gear pump 2 and moreover securing sufficiently the function of adjusting the flow rate of the resin composition 5, the upper limit of the top clearance TC is preferably 200 μm.

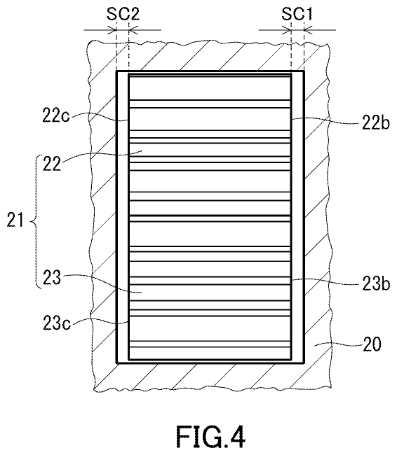

FIG. 4 shows a relationship between sides 22b and 22c of the driving gear 22 as well as sides 23b and 23c of the driven gear 23 and the housing 20. The sides 22b and 22c of the driving gear 22 face each other. The sides 23b and 23c of the driven gear 23 also face each other. As shown in FIG. 4. the sides 22b and 22c of the driving gear 22 (or the sides 23b and 23c of the driven gear 23) are preferably out of contact with the housing 20.

A distance (a side clearance) SC1 between the side 22b of the driving gear 22 (or the side 23b of the driven gear 23) and the housing 20 (specifically, an inner wall, facing the side 22b, of the housing 20) is, for example, but not particularly limited to, 5 μm or more, preferably 10 μm or more, more preferably 30 μm or more. still more preferably 50 μm or more, particularly preferably 80 μm or more, and especially preferably 100 μm or more. There is a tendency that as the side clearance SC1 increases, a shearing stress generated in the resin composition 5 between the side 22b of the driving gear 22 (or the side 23b of the driven gear 23) and the housing 20 can be more reduced. The reduction in the shearing stress generated in the resin composition 5 makes it possible to inhibit the side 22b (or the side 23b) and the housing 20 from being scraped when the driving gear 22 (or the driven gear 23) is rotating. In other words, as the side clearance SC1 increases, materials of the gear 22, the gear 23 and the housing 20 can be more inhibited from entering into the resin composition 5. In view of maintaining sufficiently the efficiency of the gear pump 2 and moreover securing sufficiently the function of adjusting the flow rate of the resin composition 5, the upper limit of the side clearance SC1 is preferably 200 μm.

A distance (a side clearance) SC2 between the side 22c of the driving gear 22 (or the side 23c of the driven gear 23) and the housing 20 (specifically, the inner wall, facing the side 22c, of the housing 20) may be equal to or different from the side clearance SC1. The side clearance SC2 is, for example, 5 μm or more, preferably 10 μm or more, more preferably 30 μm or more, still more preferably 50 μm or more, particularly preferably 80 μm or more, and especially preferably 100 μm or more. The upper limit of the side clearance SC2 is preferably 200 μm. In the present description, the side clearances SC1 and SC2 each may be a designed value of the distance between the side of the gear and the housing, or may be a minimum value of that distance. In the present description, the smaller one of the two side clearances SC1 and SC2 is simply referred to as a “side clearance SC” in some cases.

In the present embodiment, with regard to one (the gear 22 or the gear 23) of the pair of gears 21, at least one selected from the group consisting of the top clearance TC and the side clearance SC mentioned above is preferably 5 μm or more, more preferably 30 μm or more, and still more preferably 50 μm or more. Furthermore, with regard to both of the gears 22 and 23, at least one selected from the group consisting of the top clearance TC and the side clearance SC mentioned above is preferably 5 μm or more, and particularly preferably 30 μm or more. To the knowledge of the present inventors, among gear pumps that adjust a flow rate of a fluid to 1.0 mL/min or less, no gear pumps in which the top clearance TC or the side clearance SC is 30 μm or more have been known so far. Such gear pumps are particularly suitable for an apparatus for manufacturing a plastic optical fiber.

In the present embodiment, a maximum value of a shearing stress generated in the resin composition 5 between the tooth portion (the tooth portion 22a or the tooth portion 23a) of one (the gear 22 or the gear 23) of the pair of gears 21 and the housing 20 is denoted as τ_{TC} (kPa). Specifically, a maximum value of a shearing stress generated in the resin composition 5 between the tooth portion of the gear, out of the pair of gears 21, having the smaller top clearance TC and the housing 20 is denoted as τ_{TC} (kPa). In addition, a maximum value of a shearing stress generated in the resin composition 5 between the side of that gear and the housing 20 is denoted as τ_{SC} (kPa). Specifically, a maximum value of a shearing stress generated in the resin composition 5 between the side, out of two sides of that gear, having the smaller side clearance and the housing 20 is denoted as τ_{SC} (kPa). Preferably, the τ_{SC} and the τ_{TC} satisfy relational expression (I) below.

τ_{TS}≤−τ_{TC}+1200 (I)

The maximum value τ_{TC} (kPa) of the shearing stress can be calculated by formula (i) below. In the formula (i), μ is the viscosity (Pa·s) of the resin composition 5, D is the diameter (mm) of the side of the gear, N is the number of rotations (rpm) of the gear, π is a circular constant, and TO is the top clearance (μm ).

$$\begin{matrix}[ Equation 1 ] & \\ {τ}_{TC} = \frac{1}{60} \times \frac{μ DN π}{T C} & ( i )\end{matrix}$$

The maximum value τ_{TC} of the shearing stress is, for example, 1000 kPa or less, preferably 800 kPa or less, more preferably 500 kPa or less, still more preferably 400 kPa or less, and particularly preferably 100 kPa or less.

The maximum value τ_{SC} (kPa) of the shearing stress can be calculated by formula (ii) below. In the formula (ii), μ, D, N, and are as described in the formula (i). SC is the side clearance (μm ).

$$\begin{matrix}[ Equation 2 ] & \\ {T}_{SC} = \frac{0.5}{60} \times \frac{μ DN π}{S C} & ( ii )\end{matrix}$$

The maximum value τ_{SC} of the shearing stress is, for example, 1000 kPa or less, preferably 800 kPa or less, more preferably 500 kPa or less, still more preferably 400 kPa or less, and particularly preferably 100 kPa or less.

When the τ_{SC} and the τ_{TC} satisfy the relational expression (I) mentioned above, it is possible to inhibit sufficiently the pair of gears 21 or the housing 20 from being scraped when the pair of gears 21 are being driven. This makes it possible to inhibit sufficiently an impurity, such as a metal, from entering into the resin composition 5 when the pair of gears 21 are being driven.

That is, the present invention provides, in another aspect, an apparatus for manufacturing a plastic optical fiber, including:

an extruding device that extrudes the resin composition; and

a gear pump that adjusts a flow rate of the resin composition extruded from the extruding device, wherein

the gear pump has a housing with an inside through which the resin composition passes, and one or more pairs of gears that are contained in the housing and mesh with each other, and

when a maximum value of a shearing stress generated in the resin composition between a tooth portion of one of the one or more pairs of gears and the housing is denoted as τ_{TC} (kPa) and a maximum value of a shearing stress generated in the resin composition between a side of the gear and the housing is denoted as τ_{SC} (kPa), relational expression (I) below is satisfied.

τ_{TS}≤−τ_{TC}+1200 (I)

Furthermore, the present invention provides, in another aspect, a gear pump that has a housing with an inside through which a fluid (a resin composition, for example) passes, and one or more pairs of gears that are contained in the housing and mesh with each other, wherein

when a maximum value of a shearing stress generated in the fluid between a tooth portion of one of the one or more pairs of gears and the housing is denoted as τ_{TC} (kPa) and a maximum value of a shearing stress generated in the fluid between a side of the gear and the housing is denoted as τ_{SC} (kPa), relational expression (I) below is satisfied.

τ_{TS}≤−τ_{TC}+1200 (I)

More preferably, the τ_{SC} and τ_{TC} mentioned above satisfy relational expression (II) below. When the relational expression (II) below is satisfied, it is possible to further inhibit an impurity, such as a metal, from entering into the resin composition 5 when the pair of gears 21 are being driven.

τ_{TS}≤−τ_{TC}+1200 (I)

When the relational expression (I) or (II) mentioned above is satisfied, there is a tendency that an increase in a concentration of the metal in the resin composition 5 from before to after the resin composition 5 passes through the gear pump 2 can be inhibited sufficiently. The increase in the concentration of the metal in the resin composition 5 from before to after the resin composition 5 passes through the gear pump 2 is, for example, 300 mass ppm or less, preferably 250 mass ppm or less, more preferably 200 mass ppm or less, and still more preferably 100 mass ppm or less, and it may be 5 mass ppb or less, 3 mass ppb or less, 1.5 mass ppb or less, or 1 mass ppb or less in some cases.

It is possible to adjust the τ_{SC} and the τ_{TC} mentioned above to small values by decreasing the viscosity of the resin composition 5 and the number of rotations of the gear. However, an excessive decrease in the viscosity of the resin composition 5 makes it difficult to shape the resin composition 5 sent out from the gear pump 2 into a fibrous shape in some cases. An excessive decrease in the number of rotations of the gear causes the flow rate of the resin composition 5 sent out from the gear pump 2 to change in some cases. In contrast. the top clearance TC and the side clearance SC are suitable for adjusting the τ_{SC} and the τ_{TC} mentioned above to small values.

As described above, the resin composition 5 with the flow rate adjusted by the pair of gears 21 passes through the flow path 24 and is sent out from the outlet 26 of the gear pump 2. The resin composition 5 having passed through the outlet 26 moves downward in the vertical direction and is shaped into a fibrous shape, for example.

The shaped body manufactured by the manufacturing apparatus 100 is typically a fiber having a single-layer structure and being a core of the POF. The fibrous shaped body has a diameter of, for example, 300 μm or less, preferably 200 μm or less, and more preferably 150 μm or less. The lower limit of the diameter of the shaped body is, for example, 10 μm. It is possible to adjust the diameter of the shaped body by factors such as a diameter of the outlet 26, the flow rate of the resin composition 5 sent out from the gear pump 2, and a winding speed at which the shaped body is wound.

The manufacturing apparatus 100 may be further provided with a controller (not illustrated) besides the extruding device 1 and the gear pump 2. The controller is, for example, a DSP (Digital Signal Processor) including an ND conversion circuit, an input/output circuit, an arithmetic circuit, a storage device, etc. A program for operating properly the manufacturing apparatus 100 is stored in the controller. Specifically, the controller controls the driving of the servomotor of the gear pump 2. The controller may control the heater with which the extruding device 1 is provided.

In the manufacturing apparatus 100, at least a portion that is in contact with the resin composition 5 is preferably composed of a material having corrosion resistance against the resin composition 5. In the present description, the “corrosion resistance” means to be hardly corroded when being in contact with the resin composition 5. For example, it means that when a material is heated at 300° C. for 100 hours in the state in which the material is in contact with the resin composition 5, an amount of elution of the material into the resin composition 5 per square centimeter of a portion of contact is 1 μm or less. The fact that the portion that is in contact with the resin composition 5 is composed of the material having corrosion resistance makes it possible to further inhibit an impurity, such as a metal, from entering into the resin composition 5. The material having corrosion resistance against the resin composition 5 includes, for example, at least one selected from the group consisting of Hastelloy and Stellite. The Hastelloy is an alloy that includes nickel as a main component and further includes molybdenum, chromium, etc. The Stellite is an alloy that includes cobalt as a main component and further includes chromium, tungsten, etc. The “corrosion resistance” as used herein means a component whose content is highest in the mentioned alloy on a mass ratio basis.

In the manufacturing apparatus 100, as the portion that is in contact with the resin composition 5, there can be mentioned, for example, an inner surface of the containing portion 10 of the extruding device 1, an inner surface of the housing 20 of the gear pump 2, and surfaces of the pair of the gears 21. In the present embodiment, it is especially preferable that the inner surface of the housing 20 of the gear pump 2 and the surfaces of the pair of the gears 21 be composed of the material having corrosion resistance against the resin composition 5. These surfaces each are made of, for example, a coating or a thin layer composed of the material having corrosion resistance against the resin composition 5.

The entirety of each of the containing portion 10 of the extruding device 1, the housing 20 of the gear pump 2, and the pair of the gears 21 may be composed of the material having corrosion resistance against the resin composition 5. A content of the Hastelloy or that of the Stellite in the containing portion 10 is, for example, 50 mass % or more, preferably 80 mass % or more, and more preferably 90 mass % or more. The containing portion 10 may consist essentially of the Hastelloy or the Stellite.

Also, a content of the Hastelloy or that of the Stellite in the housing 20 is, for example, 50 mass% or more, preferably 80 mass % or more, and more preferably 90 mass % or more. The housing 20 may consist essentially of the Hastelloy or the Stellite. A content of the Hastelloy or that of the Stellite in the pair of gears 21 is, for example, 50 mass % or more, preferably 80 mass % or more, and more preferably 90 mass % or more. The pair of gears 21 may consist essentially of the Hastelloy or the Stellite.

In the present embodiment, the resin composition 5 preferably has a composition suitable for the core of the POF. The resin composition 5 includes a fluorine polymer (a polymer (P)), for example. In view of reducing light absorption attributable to stretching energy of a C—H bond, the polymer (P) is preferably essentially free of a hydrogen: atom, and particularly preferably, in the polymer (P), every hydrogen atom bonded to a carbon atom is substituted by a fluorine atom. The phrase “the polymer (P) is essentially free of a hydrogen atom” as used herein means that a hydrogen atom content in the polymer (P) is 1 mol % or less.

The polymer (P) preferably has a fluorine-containing aliphatic ring structure. The fluorine-containing aliphatic ring structure may be included in a principal chain of the polymer (P) or in a side chain of the polymer (P). The polymer (P) has, for example, a structural unit (A) represented by formula (1) below.

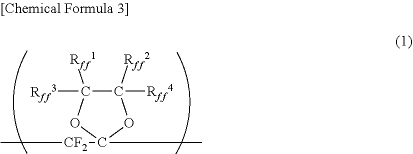

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

When R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by formulae (A1) to (A8) below.

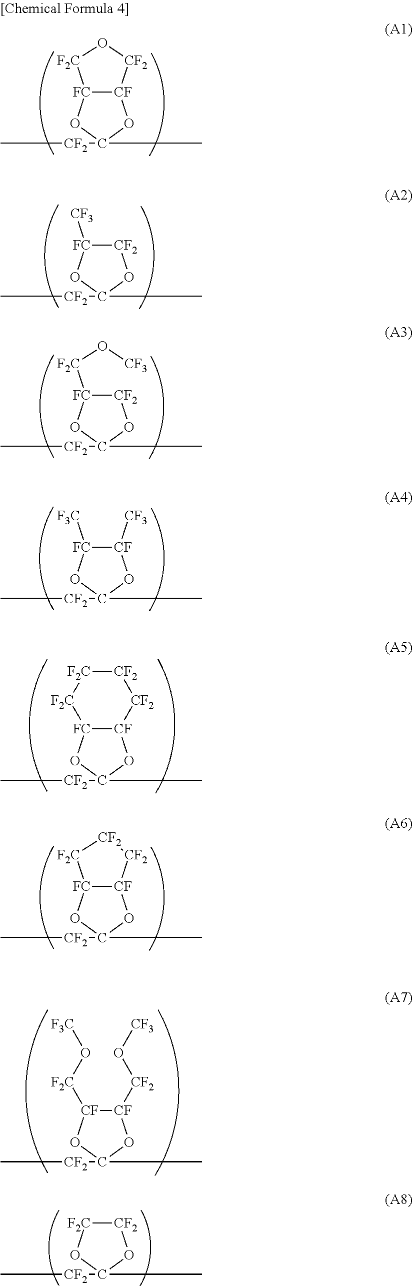

Among the structural units represented by the above formulae (A1) to (A8), the structural unit (A) is preferably the structural unit (A2), i.e., a structural unit represented by formula (2) below.

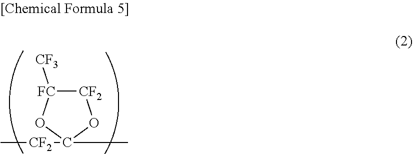

The polymer (P) may include one or more structural units (A). In the polymer (P), a content of the structural unit (A) is preferably 20 mol % or more and more preferably 40 mol % or more in a total amount of all structural units. When including 20 mol % or more of the structural unit (A), the polymer (P) tends to have much higher thermal resistance. When including 40 mol % or more of the structural unit (A), the polymer (P) tends to have much higher transparency and much higher mechanical strength in addition to high thermal resistance. In the polymer (P), the content of the structural unit (A) is preferably 95 mol % or less and more preferably 70 mol % or less in the total amount of all structural units.

The structural unit (A) is derived from, for example, a compound represented by formula (3) below. In the formula (3), R_{ff}¹ to R_{ff}⁴ are as described in the formula (1). The compound represented by the formula (3) can be obtained by a known manufacturing method such as a manufacturing method disclosed in JP 2007-504125 A.

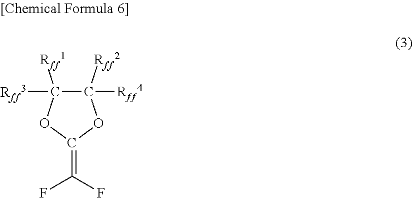

Specific examples of the compound represented by the above formula (3) include compounds represented by formulae (M1) to (M8) below.

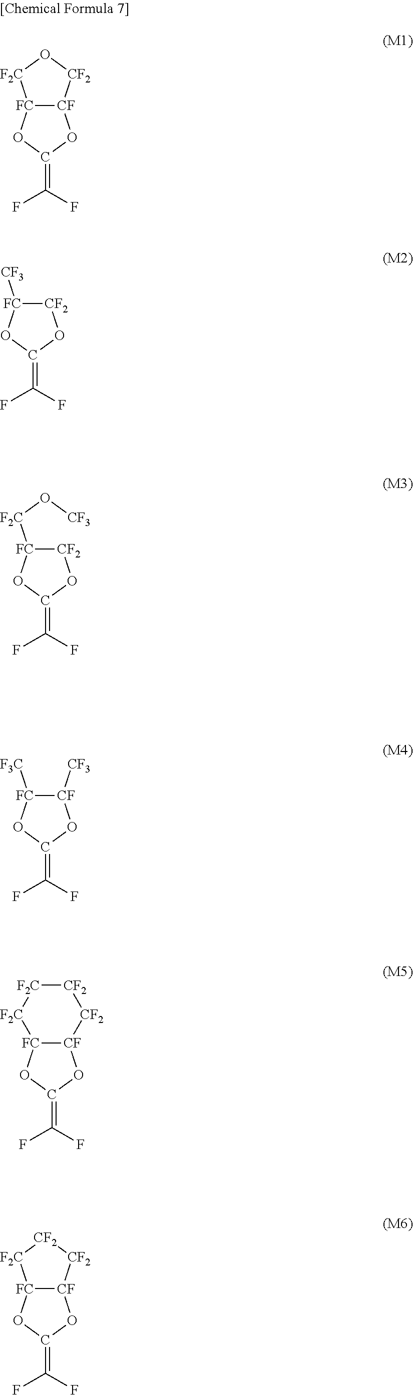

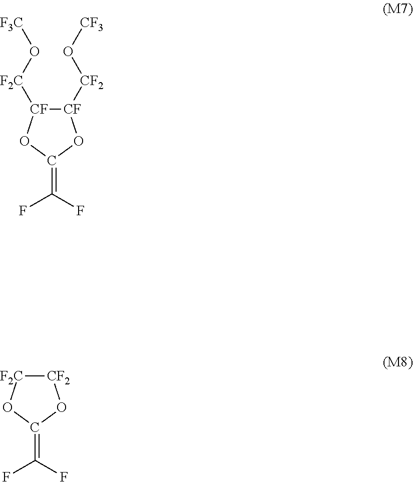

The polymer (P) may further include an additional structural unit other than the structural unit (A). Examples of the additional structural unit include the following structural units (B) to (D).

The structural unit (B) is represented by formula (4) below.

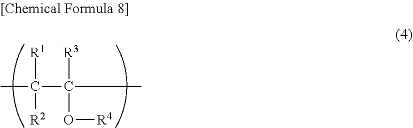

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms represented by R¹ to R³ may each be substituted by a halogen atom other than a fluorine atom. One or some of fluorine atoms in the perfluoroalkyl group may each be substituted by a halogen atom other than a fluorine atom.

The polymer (P) may include one or more structural units (B). In the polymer (P), a content of the structural unit (B) is preferably 5 to 10 mol % in the total amount of all structural units. The content of the structural unit (B) may be 9 mol % or less or 8 mol % or less.

The structural unit (B) is derived from, for example, a compound represented by formula (5) below. In the formula (5), R¹ to R⁴ are as described in the formula (4). The compound represented by the formula (5) is a fluorine-containing vinyl ether such as perfluorovinyl ether.

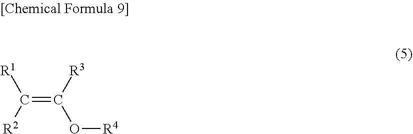

The structural unit (C) is represented by formula (6) below.

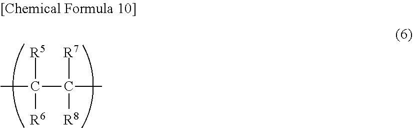

In the formula (6), R5 to R8 each independently represent a fluorine atom or a perfluoroalkyl group having 1 to 7 carbon atoms. The perfluoroalkyl group may have a ring structure. One or some of the fluorine atoms represented by R⁵ to R⁸ may each be substituted by a halogen atom other than a fluorine atom. One or some of fluorine atoms in the perfluoroalkyl group may each be substituted by a halogen atom other than, a fluorine atom.

The polymer (P) may include one or more structural units (C). In the polymer (P), a content of the structural unit (C) is preferably 5 to 10 mol % in the total amount of all structural units. The content of the structural unit (C) may be 9 mol % or less or 8 mol % or less.

The structural unit (C) is derived from, for example, a compound represented by formula (7) below. In the formula (7), R⁵ to R⁸ are as described in the formula (6).

The compound represented by the formula (7) is a fluorine-containing olefin such as tetrafluoroethylene and chlorotrifluoroethylene.

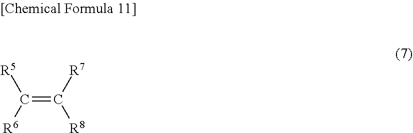

The structural unit (D) is represented by formula (8) below.

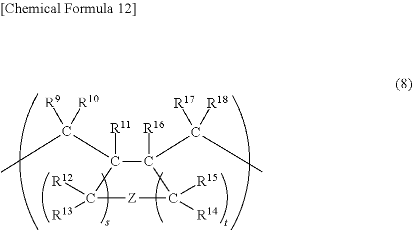

In the formula (8), Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms represented by R⁹ to R²⁰ may each be substituted by a halogen atom other than a fluorine atom. One or some of fluorine atoms in the perfluoroalkyl group may each be substituted by a halogen atom other than a fluorine atom. One or some of fluorine atoms in the perfluoroalkoxy group may each be substituted by a halogen atom other than a fluorine atom. The symbols s and t are each independently 0 to 5, and s t represents an integer of 1 to 6 (when Z is —OC(R¹⁹R²⁰)O—, s+t may be 0).

The structural unit (D) is preferably represented by formula (9) below. The structural unit represented by the following formula (9) is a structural unit represented by the above formula (8), where Z is an oxygen atom, s is 0, and t is 2.

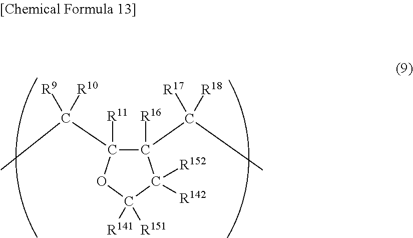

In the formula (9), R¹⁴¹, R¹⁴², R¹⁵¹, and R¹⁵² each independently represent a fluorine atom, a perfluoroalkyl group having 1 to 5 carbon atoms, or a perfluoroalkoxy group having 1 to 5 carbon atoms. One or some of the fluorine atoms represented by R¹⁴¹, R¹⁴², R¹⁵¹, and R¹⁵² may each be substituted by a halogen atom other than a fluorine atom. One or some of fluorine atoms in the perfluoroalkyl group may each be substituted by a halogen atom other than a fluorine atom. One or some of fluorine atoms in the perfluoroalkoxy group may each be substituted by a halogen atom other than a fluorine atom.

The polymer (P) may include one or more structural units (D). In the polymer (P), a content of the structural unit (D) is preferably 30 to 67 mol % in the total amount of all structural units. The content of the structural unit (D) is 35 mol % or more, for example, and it may be 60 mol % or less or 55 mol % or less.

The structural unit (D) is derived from, for example, a compound represented by formula (10) below. In the formula (10), Z, R⁹ to R¹⁸, s, and t are as described in the formula (8). The compound represented by the formula (10) is a fluorine-containing compound having two or more polymerizable double bonds and being cyclopolymerizable.

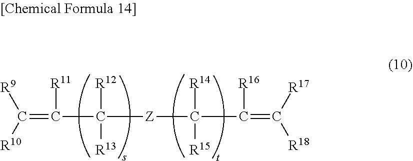

The structural unit (D) is preferably derived from a compound represented by formula (11) below. In the formula (11), R¹⁴¹, R¹⁴², R¹⁵¹, and R¹⁵² are as described in the formula (9).

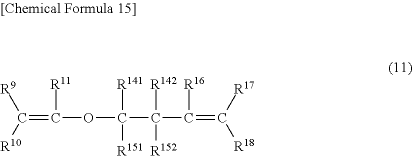

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═C FOCF₂CF(CF₃)CCl═CF₂
CF₂═CFOCF₂OCF═CF₂
CF₂═CFOCCl₂OCF═CF₂
CF₂═CClOCF₂OCCl═CF₂

The polymer (P) may further include an additional structural unit other than the structural units (A) to (D), but is preferably essentially free of an additional structural unit other than the structural units (A) to (D). The phrase “the polymer (P) is essentially free of an additional structural unit other than the structural units (A) to (D)” means that a total content of the structural units (A) to (D) is 95 mol % or, more and preferably 98 mol % or more in the total amount of all structural units in the polymer (P).

A method for polymerizing the polymer (P) is not particularly limited and a common polymerization method such as radical polymerization can be used. A polymerization initiator for polymerizing the polymer (P) may be a fully fluorinated compound.

A glass transition temperature (Tg) of the polymer (P) is, for example, but not particularly limited to, 100° C. to 140°“C., and may be 105°”C. or higher or 120° C. or higher. The term “Tg” as used herein means a midpoint glass transition temperature (T_{mg}) determined according to JIS K 7121: 1987.

The resin composition 5 may include the polymer (P) as a main component, and preferably consists essentially of the polymer (P) alone. The resin composition 5 may further include an additive such as a refractive index modifier. The resin composition 5 is, for example, a solid at an ordinary temperature (25° C.).

In the present embodiment, the resin composition 5 is extruded from the extruding device 1 by means of the gas. Therefore, an impurity. such as a metal, is unlikely to enter into the resin composition 5 extruded from the extruding device 1. An increase in the concentration of the metal in the resin composition from before to after the resin composition passes through the manufacturing apparatus 100 is, for example, 200 mass ppm or less and preferably 100 mass ppm or less, and it may be 100 mass ppb or less, 50 mass ppb or less, 10 mass ppb or less, or 5 mass ppb or less in some cases. As just described above, the manufacturing apparatus 100 of the present embodiment makes it possible to inhibit the entry of a metal that causes an increase in transmission loss of the plastic optical fiber.

In the present embodiment, the flow rate of the resin composition 5 is adjusted by the gear pump 2. Therefore, even in the case where the flow rate of the resin composition 5 extruded from the extruding device 1 has changed, the flow rate of the resin composition 5 can be made almost constant by the gear pump 2. Being able to inhibit the flow rate of the resin composition 5 from changing, the manufacturing apparatus 100 is suitable for adjusting the fibrous shaped body to be uniform in size. The change in an outer diameter (a diameter) of the fibrous shaped body manufactured by the manufacturing apparatus 100 is, for example, 5% or less, preferably 3% or less, and more preferably 1% or less. In the present description, the change in the outer diameter of the shaped body means a ratio (3σ/Ave.) of a value (3σ) obtained by triplicating a standard deviation of the outer diameter with respect to an average (Ave.) of the outer diameter. The outer diameter of the shaped body can be measured using a commercially available displacement meter.

### EMBODIMENT 2

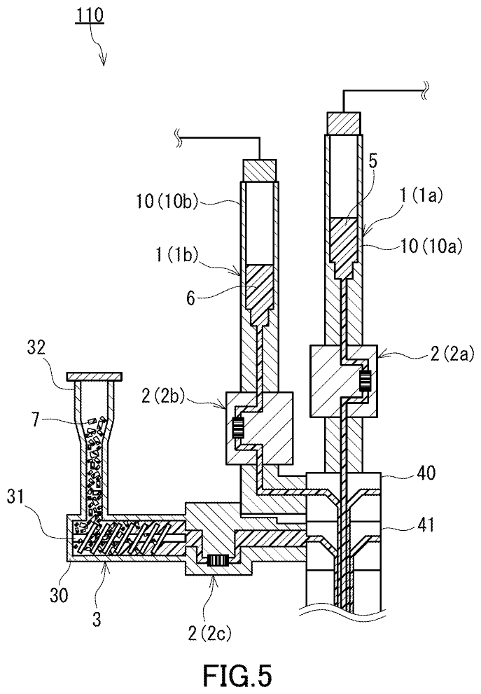

The manufacturing apparatus 100 of Embodiment 1 may be further provided with a device for coating a face of the fibrous shaped body with another resin composition different from the resin composition 5 of which the shaped body is composed. As shown in FIG. 5, a manufacturing apparatus 110 of the present embodiment 2 is provided with a plurality of extruding devices 1b and 3 and a plurality of gear pumps 2b and 2c besides the extruding device 1 (1a) and the gear pump 2 (2a) described above in Embodiment 1. The manufacturing apparatus 110 is further provided with a first room 40 and a second room 41. The first room 40 and the second room 41 are arranged in this order downward in the vertical direction. The shaped body (the resin composition 5) that has been sent out from the gear pump 2a and shaped into a fibrous shape is fed to each of the first room 40 and the second room 41 in this order.

The extruding device 1b is provided with a containing portion 10b that contains, for example, a resin composition 6 having a composition suitable for a clad of the POF As the extruding device 1b, the extruding device described above as the extruding device 1 of Embodiment 1 can be used. The extruding device 1b makes it possible to extrude the resin composition 6 from the containing portion 10b by introducing the gas into the containing portion 10b.

The resin composition 6 extruded from the extruding device 1b is sent to the gear pump 2b. As the gear pump 2b, the gear pump described above as the gear pump 2 of Embodiment 1 can be used. The gear pump 2b adjusts a flow rate of the resin composition 6 extruded from the extruding device 1b.

The resin composition 6 sent out from the gear pump 2b is fed to the first room 40. In the first room 40, the fibrous shaped body is covered with the resin composition 6, and thereby a clad that covers an outer circumference of the shaped body can be formed. The shaped body covered with the clad moves from the first room 40 to the second room 41.

The extruding device 3 is provided with, for example, a containing portion 30 that contains a resin composition 7 having a composition suitable for a coating layer (an overclad) of the POF, a screw 31 disposed in the containing portion 30, and a hopper 32 connected to the containing portion 30. In the extruding device 3, the resin composition 7 in a pellet form is fed to the containing portion 30 through the hopper 32.

The resin composition 7 in a pellet form fed to the containing portion 30 is, for example, kneaded by the screw 31 while being heated to be softened and become able to flow. The softened resin composition 7 is extruded from the containing portion 30 by the screw 31.

The resin composition 7 extruded from the extruding device 3 is sent to the gear pump 2c. As the gear pump 2c, the gear pump described above as the gear pump 2 of Embodiment 1 can be used. The gear pump 2c adjusts a flow rate of the resin composition 7 extruded from the extruding device 3.

The resin composition 7 sent out from the gear pump 2c is fed to the second room 41. In the second room 41, the clad is covered with the resin composition 7. and thereby a coating layer that covers an outer circumference of the clad can be formed. The resin composition 7 is extruded by the extruding device 3 provided with the screw 31. Therefore, the coating layer formed of the resin composition 7 includes a metal derived from the extruding device 3 in some cases. However, in the POF, a light from the core hardly reaches the coating layer. Thus, even when the coating layer includes the metal, the transmission loss of the POF hardly increases.

The resin composition 6 of which the clad of the POF is formed preferably has a refractive index lower than that of the resin composition 5 of which the core is formed. Examples of a resin material included in the resin composition 6 include a fluorine-containing resin, an acrylic resin such as methyl methacrylate, a styrene resin, and a carbonate resin. Examples of a resin material included in the resin composition 7 of which the coating layer of the POF is formed include polycarbonate, various kinds of engineering plastics, a cycloolefin polymer, PTFE, modified PTFE, and PFA.

The manufacturing apparatus 110 manufactures a shaped body with a three-layer structure provided with the core. the clad, and the coating layer. However, the structure of the shaped body manufactured by the manufacturing apparatus 110 is not limited to the three-layer structure. The structure of the shaped body may be a two-layer structure composed of the core and the clad.

### EXAMPLES

Hereinafter, the present invention will be described in detail by way of Example and Comparative Examples. It should be noted that the present invention is not limited to these examples.

### Measurement Example 1

First, a gear pump having a housing and a pair of gears was prepared. The pair of gears were identical to each other in terms of dimensions and shape. As for each of the pair of gears, a minimum value (a top clearance) TC of a distance between a tooth portion of the gear and the housing was 100 μm. A minimum value (a side clearance) SC of a distance between a side of the gear and the housing was 110 μm. The side of the gear had a diameter of 12 mm. The entirety of each of the housing and the pair of gears was composed of Stellite. The Stellite of which the gear pump was composed included cobalt as a main component and included no iron.

A silicone oil was poured into the gear pump, and an increase in a concentration of the cobalt in the silicone oil from before to after the silicone oil had passed through the gear pump was measured. Here, the number of rotations of the gears in the gear pump was adjusted to 10 rpm. The silicone oil had a viscosity of 1000 Pa·s. Table 1 shows a maximum value τ_{TC} (kPa) of a shearing stress generated in the silicone oil between the tooth portion of the gear and the housing, a maximum value τ_{SC} (kPa) of a shearing stress generated in the silicone oil between the side of the gear and the housing, and the increase in the concentration of the cobalt in the silicone oil from before to after the silicone oil had passed through the gear pump.

### Measurement Examples 2 to 18

The increase in the concentration of the cobalt in the silicone oil from before to after the silicone oil had passed through the gear pump was measured in the same manner as in Measurement Example 1. except that the top clearance TC, the side clearance SC, the diameter D of the side of the gear, the number N of rotations of the gear, and the viscosity μ of the silicone oil in the gear pump were changed to the values shown in Table 1.

TABLE 1

| | | | Gears | | | | | Increase in |
|---|---|---|---|---|---|---|---|---|
| | Top | Side | Diameter D | The number N | | | | concentration |
| Measurement | clearance | clearance | of side | of rotations | Viscosity μ | T_{TC} | T_{SC} | of cobalt |
| Example | TC [μm] | SC [μm] | [mm] | [rpm] | [Pa · s] | [kPa] | [kPa] | [mass ppb] |
| 1 | 100 | 110 | 12 | 10 | 1000 | 63 | 29 | 0 |
| 2 | 16 | 10 | 12 | 1 | 1000 | 39 | 31 | 1 |
| 3 | 16 | 10 | 12 | 3 | 2000 | 236 | 188 | 1 |
| 4 | 16 | 10 | 12 | 2 | 2000 | 157 | 126 | 1 |
| 5 | 100 | 10 | 12 | 4 | 2000 | 50 | 251 | 1 |
| 6 | 16 | 110 | 12 | 3 | 2000 | 236 | 17 | 1 |
| 7 | 16 | 110 | 12 | 5 | 2000 | 393 | 29 | 1 |
| 8 | 16 | 10 | 12 | 10 | 1000 | 393 | 314 | 1.4 |
| 9 | 16 | 10 | 12 | 3 | 5000 | 589 | 471 | 4.2 |
| 10 | 50 | 10 | 20 | 9 | 1000 | 188 | 471 | 4 |
| 11 | 16 | 110 | 20 | 6 | 2000 | 785 | 57 | 4 |
| 12 | 50 | 10 | 20 | 2.5 | 5000 | 262 | 654 | 4.3 |
| 13 | 50 | 110 | 20 | 9 | 5000 | 942 | 214 | 5 |
| 14 | 16 | 10 | 20 | 6 | 2000 | 785 | 628 | 6 |
| 15 | 16 | 10 | 12 | 6 | 5000 | 1178 | 942 | 6.9 |
| 16 | 16 | 10 | 12 | 12 | 2000 | 942 | 754 | 8.2 |
| 17 | 50 | 10 | 20 | 3.5 | 5000 | 367 | 916 | 7 |
| 18 | 50 | 100 | 20 | 10 | 5000 | 1047 | 262 | 5.2 |

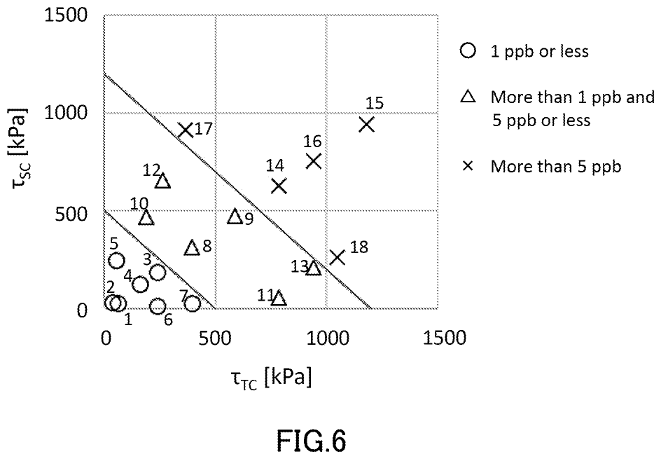

FIG. 6 is a graph showing a relationship between the maximum values τ_{TC} and τ_{SC} of the respective shearing stresses in each of Measurement Examples 1 to 18. As can be understood from Table 1 and FIG. 6, in the gear pumps of Measurement Examples 1 to 13 satisfying the relational expression (I) (τ_{SC}≤−τ_{TC}+1200), the increase in the concentration of the cobalt in the silicone oil from before to after the silicone oil had passed through the gear pump was more suppressed than in the gear pumps of Measurement Examples 14 to 18. Especially, in the gear pumps of Measurement Examples 1 to 7 satisfying the relational expression (II) (τ_{TC}≤−τ_{TC}+500), the increase in the concentration of the cobalt in the silicone oil was further suppressed.

In FIG. 6, the symbol indicates a measurement example in which the increase in the concentration of the cobalt was 1 ppb or less. The symbol Δ indicates a measurement example in which the increase in the concentration of the cobalt was more than 1 ppb and 5 ppb or less. The symbol x indicates a measurement example in which the increase in the concentration of the cobalt was more than 5 ppb.

### Example 1

A manufacturing apparatus (see FIG. 1) provided with an extruding device that can extrude a resin composition by means of a gas and the gear pump used in Measurement Example 1 was prepared. The resin composition was extruded by means of a gas using the extruding device, and further a flow rate of the extruded resin composition was adjusted by the gear pump. The resin composition was composed of polycarbonate. The resin composition was heated to 240° C. before being extruded from the extruding device. The heated resin composition had a viscosity of 2000 Pa·s. The resin composition sent out from the gear pump had a flow rate of 5.9 mL/min. The extruding device was composed of iron.

Next, the resin composition sent out from the gear pump was wound while being cooled and shaped into a fibrous shape. A winding speed at which the resin composition was wound was 30 m/min. An outer diameter of the resultant shaped body was adjusted to 0.5 mm.

The fibrous shaped body was measured for outer diameter before reaching a winding-up bobbin by using a displacement meter (LS-9006M available from KEYENCE CORPORATION). The duration for which the outer diameter was measured was 0.1 second. and the number of points at which the outer diameter was measured was 50000. Based on the obtained results, the change (3σ/Ave.) in the outer diameter was calculated. In addition, the increase in the concentration of each of the metals in the resin composition from before to after the resin composition passed through the manufacturing apparatus was measured. Table 2 shows the results.

### Comparative Example 1

A fibrous shaped body was obtained in the same manner as in Example 1, except that the gear pump was omitted from the manufacturing apparatus and the resin composition extruded from the extruding device was shaped into a fibrous shape. In addition, the change (3σ/Ave.) in the outer diameter of the shaped body and the increase in the concentration of each of the metals in the resin composition from before to after the resin composition had passed through the manufacturing apparatus were determined in the same manner as in Example 1.

### Comparative Example 2

A fibrous shaped body was obtained in the same manner as in Example 1, except that a single-screw extruder provided with a screw was used as the extruding device. The single-screw extruder was made of chromium-molybdenum steel (SCN435). The SCN435 included iron as a main component and included no cobalt. In addition, the change (3σ/Ave.) in the outer diameter of the shaped body and the increase in the concentration of each of the metals in the resin composition from before to after the resin composition had passed through the manufacturing apparatus were determined in the same manner as in Example 1.

TABLE 2

| | | | | | Outer | Change in | | |
|---|---|---|---|---|---|---|---|---|
| | | | | | diameter of | outer | Increase | Increase |
| | | | Amount of | | shaped | diameter | in Fe | in Co |
| | | | discharge | Winding speed | body | 3σ/Ave. | concentration | concentration |
| | Extrusion | Measurement | [mL/min] | [m/min] | ϕ [mm] | [%] | [mass ppb] | [mass ppb] |
| Example 1 | Gas | Gear | 5.9 | 30 | 0.5 | 1 | 0 | 1 |
| | extrusion | pump | | | | | | |
| Comparative | Gas | Omitted | 5.9 | 30 | 0.5 | 10 | 0 | 0 |
| Example 1 | extrusion | | | | | | | |
| Comparative | Single- | Gear | 5.9 | 30 | 0.5 | 1 | 112 | 1.1 |
| Example 2 | screw | pump | | | | | | |
| | extrusion | | | | | | | |

As can be understood from Table 2, according to the manufacturing apparatus of Example 1 provided with the extruding device that can extrude the resin composition by means of the gas and the gear pump, it was possible to shape the resin composition into a fibrous shape that was uniform in size while inhibiting the entry of the metals into the resin composition.

### INDUSTRIAL APPLICABILITY

The manufacturing apparatus of the present embodiment is suitable for manufacturing the POF.

1. An apparatus for manufacturing a plastic optical fiber, comprising:
an extruding device that has a containing portion that contains a resin composition, and introduces a gas into the containing portion to extrude the resin composition from the containing portion by means of the gas; and
a gear pump that adjusts a flow rate of the resin composition extruded from the extruding device.

2. A method for manufacturing a plastic optical fiber by using the manufacturing apparatus according to claim 1, comprising
causing the resin composition extruded from the extruding device to pass through the gear pump, wherein
the gear pump has a housing with an inside through which the resin composition passes, and one or more pairs of gears that are contained in the housing and mesh with each other, and
when a maximum value of a shearing stress generated in the resin composition between a tooth portion of one of the one or more pairs of gears and the housing is denoted as τ_{TC} (kPa) and a maximum value of a shearing stress generated in the resin composition between a side of the gear and the housing is denoted as τ_{SC} (kPa), relational expression (I) below is satisfied.
τ_{TS}≤−τ_{TC}+1200 (I)

3. The method for manufacturing a plastic optical fiber according to claim 2, wherein at least one selected from the group consisting of a distance between the tooth portion of the gear and the housing and a distance between the side of the gear and the housing is 5 μm or more.

4. The method for manufacturing a plastic optical fiber according to claim 2, wherein the side of the gear has a diameter of 80 mm or less.

5. The method for manufacturing a plastic optical fiber according to claim 2, wherein a number of rotations of the gear is 100 rpm or less.

6. The method for manufacturing a plastic optical fiber according to claim 2, wherein an inner surface of the housing is composed of a material having, corrosion resistance against the resin composition.

7. The method for manufacturing a plastic optical fiber according to claim 2, wherein a surface of the one or more pairs of gears is composed of a material having corrosion resistance against the resin composition.

8. The method for manufacturing a plastic optical fiber according to claim 6, wherein the material includes at least one selected from the group consisting of Hastelloy and Stellite.

9. A method for manufacturing a plastic optical fiber by using the manufacturing apparatus according to claim 1, comprising:
extruding the resin composition from the extruding device, wherein
the resin composition extruded from the extruding device has a viscosity of 1 to 7000 Pa·s.

10. A method for manufacturing a plastic optical fiber by using the manufacturing apparatus according to claim 1, comprising:
sending out the resin composition from the gear pump, wherein
the resin composition sent out from the gear pump has a flow rate of 20 L/min or less.

11. A method for manufacturing a plastic optical fiber by using the manufacturing apparatus according to claim 1, comprising:
causing the resin composition extruded from the extruding device to pass through the gear pump, wherein
an increase in a concentration of a metal in the resin composition from before to after the resin composition passes through the gear pump is 100 mass ppm or less.

12. A method for manufacturing it optical fiber by using the manufacturing apparatus according to claim 1, comprising
manufacturing a plastic optical fiber by using a resin composition including a polymer haying a structural unit represented by formula (1) below: 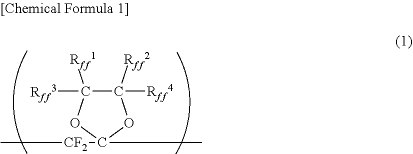
where R_{ff}¹ to R_{ff}⁴ each independently represent a fluorine atom, a perfluoroalkyl group haying 1 to 7 carbon atoms, or a perfluoroalkyl ether group haying 1 to 7 carbon atoms, and R_{ff}¹ and R_{ff}² are optionally linked to form a ring.

13. A method for manufacturing a plastic optical fiber by using the manufacturing apparatus according to claim 1, comprising:
shaping the resin composition sent out from the gear pump into a fibrous shape.
